(19) United States
(12) Patent Application Publication
(10) Pub. No.: US 2020/0178352 A1
(43) Pub. Date: Jun. 4, 2020

(54) SYSTEM AND METHOD FOR MULTI-MODE INTEGRATED MANAGEMENT FOR MULTI-RADIO COMMUNICATION ENVIRONMENT

(71) Applicant: Electronics and Telecommunications Research Institute, Daejeon (KR)

(72) Inventors: Han Byeog CHO, Daejeon (KR); Hyun Seo OH, Daejeon (KR); Ho Kyom KIM, Daejeon (KR); Nak Seon SEONG, Daejeon (KR); Byung Tae JANG, Daejeon (KR)

(73) Assignee: Electronics and Telecommunications Research Institute, Daejeon (KR)

(21) Appl. No.: 16/700,786

(22) Filed: Dec. 2, 2019

(30) Foreign Application Priority Data
Nov. 30, 2018 (KR) 10-2018-0151517

(51) Int. Cl. H04W 88/06; H04L 12/24

(52) U.S. Cl. CPC H04W 88/06; H04L 41/5096; H04L 41/5051; H04L 41/5025; H04L 41/0896

(57) ABSTRACT

Provided are a system and method for multi-mode integrated management for a multi-radio communication environment. The system includes a receiver configured to receive radio channel state information, a memory in which a program for operating an access point division in consideration of the radio channel state information is stored, and a processor configured to execute the program, wherein the processor manages an interface between a cellular base station and a radio access control device.

### CROSS-REFERENCE TO RELATED APPLICATION

This application claims priority to and the benefit of Korean Patent Application No. 10-2018-0151517, filed on Nov. 30, 2018, the disclosure of which is incorporated herein by reference in its entirety.

### BACKGROUND

### 1. Field of the Invention

The present invention relates to a system and method for multi-mode integrated management for multi-radio communication environment.

### 2. Discussion of Related Art

Recently, as 5G cellular communication technology and WiFi technology, such as IEEE802.11ax, have been spotlighted, the importance of multi-mode communication is emphasized as a core basis of wireless communication, telecommunication service providers are establishing and promoting a service utilization plan that integrates all communication systems into one communication area.

However, even if a 5G system is constructed, when users gather densely in a specific area, such as an athletic stadium, data transmission rate inevitably increases and fees also increase.

### SUMMARY OF THE INVENTION

The present invention provides a system and method capable of proving a cloud-based wireless platform using multiple radio access technologies and facilitating a multi-mode integration management in a multi-radio communication environment.

The technical objectives of the present invention are not limited to the above, and other objectives may become apparent to those of ordinary skill in the art based on the following descriptions.

According to one aspect of the present invention, there is provided a system for multi-mode integrated management for a multi-radio communication environment, the system including a receiver configured to receive radio channel state information, a memory in which a program for operating an access point division in consideration of the radio channel state information is stored, and a processor configured to execute the program, wherein the processor manages an interface between a cellular base station and a radio access control device.

### BRIEF DESCRIPTION OF THE DRAWINGS

FIG. 1 is a block diagram illustrating a system for multi-mode integrated management for a multi-radio communication environment according to an embodiment of the present invention.

FIG. 2 is a diagram illustrating a configuration of a service platform of a system for multi-mode integrated management for a multi-radio communication environment according to an embodiment of the present invention.

FIG. 3 illustrates an example of application of a service platform according to an embodiment of the present invention.

FIG. 4 is a block diagram illustrating a system for multi-mode integrated management for a multi-radio communication environment according to an embodiment of the present invention.

FIG. 5 is a flowchart showing a method of multi-mode integrated management for a multi-radio communication environment according to an embodiment of the present invention.

FIG. 6 illustrates a detailed flowchart showing a method of multi-mode integrated management for a multi-radio communication environment according to an embodiment of the present invention.

FIG. 7 is a view illustrating an example of a computer system in which a method according to an embodiment of the present invention is performed.

FIG. 8 illustrates overview of WLAN interworking to 3GPP core network

FIG. 9 illustrates WLAN interworking reference model to 5G core network

FIG. 10 illustrates a Control Plane between UE and N3IWF.

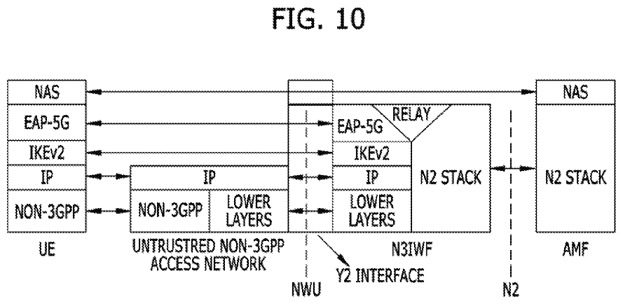

FIG. 11 illustrates Y2 interface.

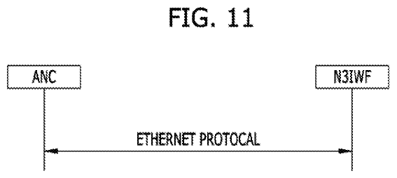

FIG. 12 illustrates NWu interface.

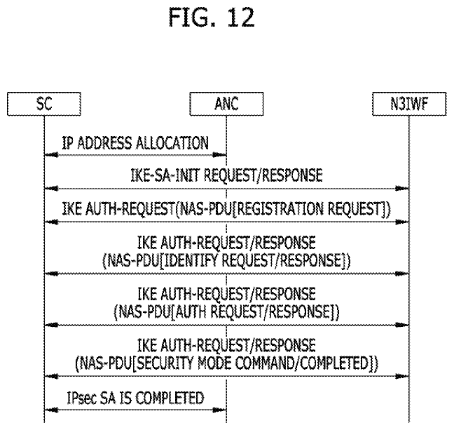

FIG. 13 illustrates N1 interface.

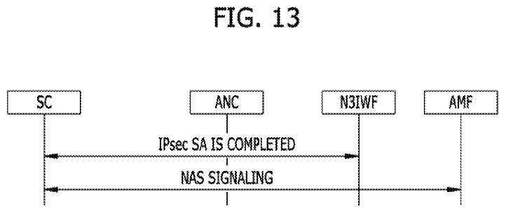

FIG. 14 illustrates Data Plane between UE and N3IWF.

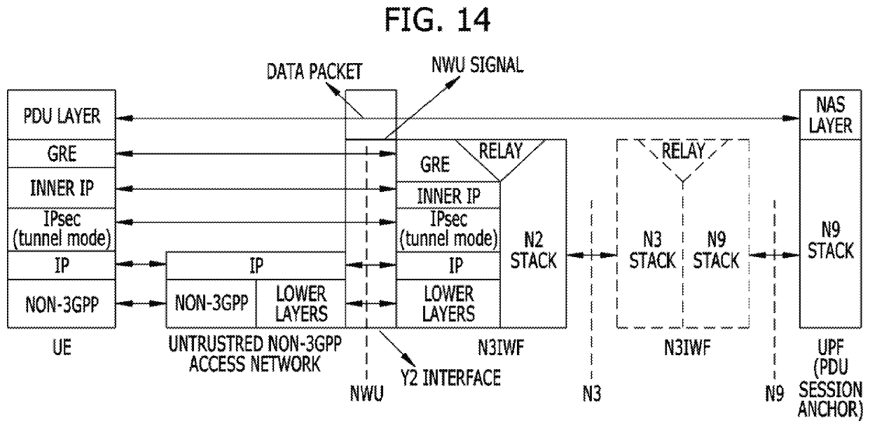

FIG. 15 illustrates ATSSS between UE and UPF.

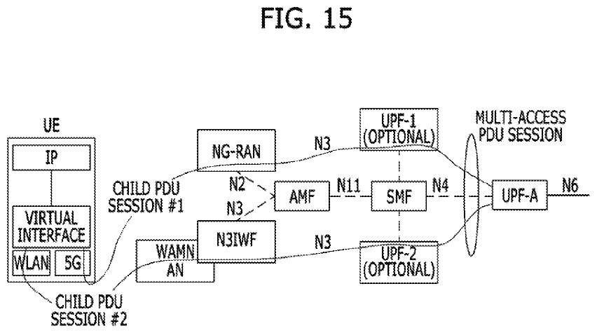

### DETAILED DESCRIPTION OF EXEMPLARY EMBODIMENTS

Hereinafter, the above and other objectives, advantages and features of the present invention and manners of achieving them will become readily apparent with reference to descriptions of the following detailed embodiments when considered in conjunction with the accompanying drawings.

However, the present invention is not limited to such embodiments and may be embodied in various forms. The embodiments to be described below are provided only to assist those skilled in the art in fully understanding the objectives, constitutions, and the effects of the invention, and the scope of the present invention is defined only by the appended claims.

Meanwhile, terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Before describing the embodiments of the present invention, a background for proposing the present invention will be described for the sake of the understanding for those skilled in the art, and then the embodiments of the present invention will be described.

Recently, as 5G cellular communication technology and WiFi technology, such as IEEE802.11ax, have been spotlighted, the importance of multi-mode communication is emphasized as a core basis of radio communication, and thus telecommunication service providers are establishing and promoting a service utilization plan that integrates all communication systems into one communication area.

However, even if a 5G system is constructed, when users gather densely in a specific area, such as an athletic stadium, data transmission rate inevitably increases and fees also increase.

A structure for integrating a 5G system and an IEEE 802 system is being studied. The IEEE802.11 working group and the WiFi Alliance (WFA) are consistently developing to improve the transmission rate, expand the service coverage, and increase convenience, and in particular, a wireless local area network (WLAN) technology has become more versatile and faster to meet a variety of needs, such as wide service coverage, high transmission rate, and extended user support.

In order to expand the WLAN service in a specific area, the IEEE 802.11ax technology is employed such that quality of service (QoS) is ensured on the basis of overall channel performance improvement of wired/wireless integrated networks.

A Type-3 communication scheme (send and receive) proposed to improve the performance of wired/wireless integrated networks and improve the mobility that needs to be provided over directly related wired/wireless networks, that is, a communication scheme via ACK, causes fatal performance deterioration with increasing density of terminals when the number of connected terminals increases.

Hereinafter, the background technology of wired/wireless communication according to the conventional technology is described in relation to a configuration and procedure including different radio access technologies (RAT).

The wireless communication system according to the convention technology transmits packet data of a speech, an image, and the like using various types, such as unicast, multicast, broadcast, and the like, and provides communication contents.

The wireless communication system is a multiple access system that may support communication with multiple users by sharing available system resources (e.g., time, frequency, and power).

Examples of the multiple access system include a code division multiple access (CDMA) system, a time division multiple access (TDMA) system, a frequency division multiple access (FDMA) system, an orthogonal frequency division multiple access (OFDMA) system, and the like.

In general, the wireless multiple access communication system may include multiple base stations, and each base station simultaneously supports communication for multiple mobile devices.

The base stations may communicate with the mobile devices through downstream and upstream links, and each base station has a coverage range which may be referred to as a coverage area of a cell.

In a system using different RATs, an access mode handover between different RATs, such as 4G (e.g., LTE) or 5G, and IEEE802, may not be supported.

In some cases, user equipment (UE) may use idle mode procedures to return from 4G to 5G, but the procedures may take a long time.

Integrating different RATs is becoming common in mobile phones or smart phones, and services thereof are provided by a large number of mobile communication providers.

Currently, there is a standard technology of licensed assisted access (LAA) and LTE-WiFi link aggregation (LWA) that groups unlicensed frequency bands usable without a license and licensed frequency bands only usable with a license together such that mobile communication providers provide services at a high transmission rate.

IEEE 802.11ax is known as Wi-Fi 6 and belongs to the IEEE 802.11 WLAN family.

Currently, IEEE 802.11ax is designed to operate in the 2.4 and 5 GHz frequency bands and is used with other available additional bands, for example, between 1 GHz to 7 GHz.

In order to enhance the overall frequency efficiency, IEEE 802.11ax adds OFDMA technology together with multiple-input and multiple-output (MIMO) and multi-user MIMO (MU-MIMO) technologies and supports 1024-Quadrature Amplitude Modulation (QAM) modulation to increase the throughput.

On the specification, IEEE 802.11ax provides a 37% improvement of data transmission rate over IEEE 802.11ac, but according to the new revision, IEEE 802.11ax is expected to have user throughput four times higher than that of IEEE 802.11ac through more efficient frequency usage.

The data transmission rate of IEEE802.11ax is calculated according to modulation types as shown in Table 1 below.

TABLE 1
Modulation and coding schemes for single spatial stream

| | | | Data rate (in Mb/s) | | | | | | | |
|---|---|---|---|---|---|---|---|---|---|---|
| | | | 20 MHz | | 40 MHz | | 80 MHz | | 160 MHz | |
| | | | channels | | channels | | channels | | channels | |
| MCS | Modulation | Coding | 1600 ns | 800 ns | 1600 ns | 800 ns | 1600 ns | 800 ns | 1600 ns | 800 ns |
| index | type | rate | GI | GI | GI | GI | GI | GI | GI | GI |
| 1 | QPSK | ½ | 16 | 17 | 33 | 34 | 68 | 72 | 136 | 144 |
| 2 | QPSK | ¾ | 24 | 26 | 49 | 52 | 102 | 108 | 204 | 216 |
| 3 | 16-QAM | ½ | 33 | 34 | 65 | 69 | 136 | 144 | 272 | 282 |
| 4 | 16-QAM | 3/4/ | 49 | 52 | 98 | 103 | 204 | 216 | 408 | 432 |
| 5 | 64-QAM | ⅔ | 65 | 69 | 130 | 138 | 272 | 288 | 544 | 576 |
| 6 | 64-QAM | ¾ | 73 | 77 | 146 | 155 | 306 | 324 | 613 | 649 |
| 7 | 64-QAM | ⅚ | 81 | 86 | 163 | 172 | 340 | 360 | 681 | 721 |
| 8 | 256-QAM | ¾ | 98 | 103 | 195 | 207 | 408 | 432 | 817 | 865 |
| 9 | 256-QAM | ⅚ | 108 | 115 | 217 | 229 | 453 | 480 | 907 | 961 |
| 10 | 1024-QAM | ¾ | 122 | 129 | 244 | 258 | 510 | 540 | 1021 | 1081 |
| 11 | 1024-QAM | ⅚ | 135 | 143 | 271 | 287 | 567 | 600 | 1134 | 1201 |

[a] MCS 9 is not applicable to all channel width/spatial stream combinations
[b] GI refers to a guard interval

Unlike the existing 3G/4G, with emergence of 5G, a great network innovation of introducing wireless technology along with wired technology is expected to occur.

Such a 5G innovation is spreading in various industries to accelerate the development of autonomous driving and connected cars in the automotive industry. Internet of Things (IoT) using 5G is examined on the utilization not only for vehicles, but also for medical, safety/security, construction (remote control: remote sensing), entertainment, and other fields, and empirical experiments thereof have already started.

In addition, the emergence of various services using 5G causes traffic to be increased, which is exerting an influence not only on a radio access section but also on a base station, a transmission device, a data center, and the like.

In general, an 802.11 AP is wirelessly connected to a terminal through a wired network.

However, since 5G uses a wireless network as well for a backhaul, a wireless AP control device (hereinafter, referred to as an access control device) capable of controlling a plurality of wireless access points (APs) is needed.

The function of the access control device is the basis of network technology for cloud management, and according to functions of providing a plurality of connections and collecting and processing big data, traffic of the wireless communication network is distributed such that optimization of the network management is achieved.

In order to ensure connectivity and compatibility with a service platform, there is a need to ensure QoS for providing a specific service (network slicing) and select an IEEE802.11ax linkage technique to increase communication network efficiency for reducing operation costs.

When a certain percentage of the capacity of a cellular base station is used, for example, 90% or more, this situation is considered a terminal dense situation, which requires a switch to a WiFi communication network, and information required for the switch is provided.

However, even in a state in which the service usage rate exceeds a preset rate, when QoS at a certain level or higher is required, the mobile communication network is continuously used, and otherwise, a handover is performed with a wireless AP to select a specific technology provided by the IEEE 802.11ax and provide a service.

There is a need to perform a mode conversion function such that OFDMA for effectively using all time slots is utilized for explosion in small packet users, and MU-MIMO is utilized for a service in which a small number of users require a high-speed data transmission capacity.

OFDMA divides frequencies in the time frequency resource unit (each AP).

A wireless AP control device for a cloud determines a path of WiFi communication or cellular communication (from an upper level) to transmit and receive data to and from a cellular base station.

Central scheduling of a collision overhead of the cellular base station may be avoided, and efficiency in a dense base station construction scenario may be enhanced.

In order to provide 5 Gbps-level data processing capacity, IEEE802.11ax technology is used in addition to 5G communication technology, and in order to provide a cloud-based wired/wireless network integrated solution, network devices are formed as clouds.

The criterion for switching a cellular communication path, such as 5G, to a WiFi communication path includes the quality of service (QoS) of an application, the ratio of usage to throughput of a cellular communication, the efficiency of network slicing, and the like.

The present invention has been proposed to remove the above-described limitations and, in order to improve the shortcomings associated with enormous installation cost and complexity of operation from installation of the base station according to the conventional technology, proposes a structure for efficiently controlling communication between a terminal and a base station required for high-speed large-scale group communication and provides a system and method for multi-mode integrated management capable of allocating the overall communication capacity, performing effective QoS management, and optimizing system performance.

According to an embodiment of the present invention, there is provided a system and method for switching a communication scheme between a plurality of communication schemes and ensuring the maximum throughput and QoS in the communication network.

According to an embodiment of the present invention, when the communication demand rapidly increases in a dense region, such as an athletic stadium and the like, a WiFi area is expanded together with expansion of a mobile base station so that high-speed transmission of communication is enabled.

According to an embodiment of the present invention, a high-speed communication network for using the Internet, watching a movie, and the like in a residential area, such as an apartment or a house, is constructed, and a high-speed service is provided.

According to an embodiment of the present invention, a large-capacity high-speed communication network may be constructed in a large-scale station building, a memorial hall in which a large crowd of people gathers, for example, in an Independence Movement Day memorial ceremony, a theater, or the like.

According to an embodiment of the present invention, a high-speed communication service may be provided in public transportation a large number of people are riding, such as a bus or subway.

According to an embodiment of the present invention, high quality educational materials may be provided to a crowded educational center, such as a large classroom, at a high speed.

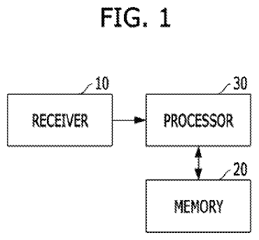

FIG. 1 is a block diagram illustrating a system for multi-mode integrated management for a multi-radio communication environment according to an embodiment of the present invention.

The system for multi-mode integrated management for a multi-radio communication environment according to the embodiment of the present invention includes a receiver 10 configured to receive radio channel state information, a memory 20 in which a program for operating an AP division in consideration of the radio channel state information is stored, and a processor 30 configured to execute the program, wherein the processor 30 manages an interface between a cellular base station and a radio access control device.

The processor 30 according to the embodiment of the present invention manages the interface in consideration of at least one factor of a terminal density, a data transmission speed, and mobility.

The processor 30 calculates a total bandwidth usage according to a service category for each terminal, compares the calculated total bandwidth usage with a threshold value, and determines whether to continue providing a cellular service in consideration of a QoS requirement level of an application in execution when the total bandwidth usage is greater than the threshold value.

The processor 30 provides a service using a WiFi communication network according to the QoS requirement level, monitors whether the usage exceeds an AP capacity, switches a path into a neighboring AP when the usage exceeds the AP capacity, and provides a service.

The processor 30 transmits a transfer command for a neighboring AP.

That is, when there is determined to be difficulty in providing a smooth service even when the path is switched to the neighboring AP, the processor 30 transmits a command for moving a currently available neighboring AP to a dense region so that a service is provided more smoothly.

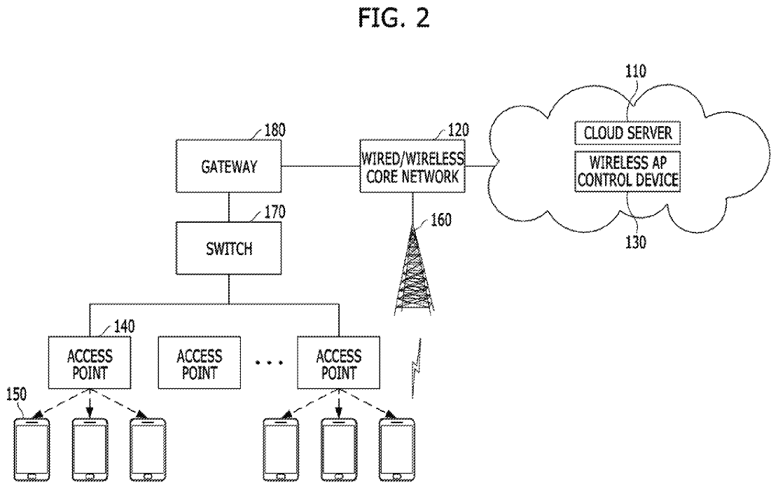

FIG. 2 is a diagram illustrating a configuration of a service platform of a system for multi-mode integrated management for a multi-radio communication environment according to an embodiment of the present invention.

FIG. 2 illustrates a service platform system of a cloud-based wired/wireless integrated communication network required for intelligent multi-mode integration of a wireless communication system that supports multiple media which shows a structure for enhancing the utilization efficiency of a network by distributing data while guaranteeing QoS according to a service policy.

Referring to FIG. 2, a cloud server 110, a wired/wireless core network 120, a wireless AP control device 130, APs 140, terminals 150, a cellular base station 160, a switch 170, and a gateway 180 are illustrated.

The cloud server 110 serves as a centralized server while being connected to the wireless AP control device 130 and manages a policy for performing network management.

The wired/wireless core network 120 refers to a core network of a 5G or other cellular networks to be developed in the future and serves to perform transmission for operating the cloud server 110 and the terminal 150.

The wireless AP control device 130 detects that the terminals are densely located and there is a possibility to reach a communication failure state, distributes data traffic to a WLAN to prevent overload of the base station, and manages wireless routers (the APs 140).

The AP 140 is an AP operating in a WLAN and serves to communicate between the terminal 150 and the cloud service platform.

The terminal 150 is equipped with both of a WiFi module and a cellular module.

When the terminal 150 receives data from the cloud server 110, the terminal 150 receives the data through cellular or WiFi according to a traffic distribution policy.

The cellular base station 160 is an endpoint of a network that transmits data to the terminal 150, such as an Evolved Node B (eNB), and utilizes a WiFi system to smoothly provide a data service in a dense region.

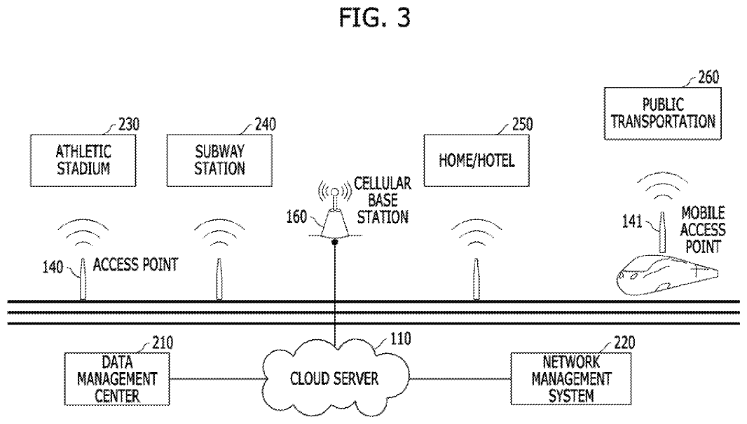

FIG. 3 illustrates an example of application of a service platform according to an embodiment of the present invention.

According to the embodiment of the present invention, a radio channel state is monitored, a mode conversion is determined, and data is transmitted through an acquired radio channel.

The service platform according to the embodiment of the present invention may be applied to a terminal-dense structure and may be mainly applied to a case in which the number of terminals connected is large or the number of terminals in use is large, such as an athletic stadium 230, a station 240, a home/hotel 250, a studio apartment, a public transportation 260, and the like.

A data management center 210 checks the quality of each service provided from the cloud server 110 to effectively manage radio resources for data transmission.

A network management system 220 identifies a location of a currently connected terminal and manages the connection so as not to be disconnected.

In the case of the athletic stadium 230, due to the high terminal density, a large number of users simultaneously require high speed data throughput.

In the case of the station 240, the terminal density is high, but the required data rate varies from user to user.

In the case of the school, high-speed multimedia services may be frequently required depending on the quality of education.

In the case of the home/hotel 250, the number of subscribers is not large, but high-speed data throughput is required.

In the case of the public transportation 260, such as an express bus or a train, due to the high movement speed, mobility management is important, and thus the required data transmission rate may vary from user to user.

According to the embodiment of the present invention, each device is set to have a maximum throughput performance between a master AP and a slave AP using a wireless distribution system (WDS) function of the AP 140, and a session for producing the maximum performance is set, and the average throughput performance over a certain period of time is measured.

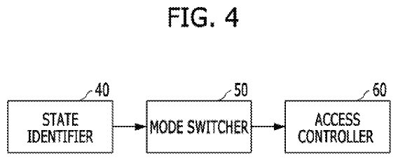

FIG. 4 is a block diagram illustrating a system for multi-mode integrated management for a multi-radio communication environment according to an embodiment of the present invention.

The system for multi-mode integrated management for the multi-radio communication environment according to the embodiment of the present invention includes a state identifier 40 configured to monitor a radio channel state, a mode switcher 50 configured to determine whether to switch a mode according to a result of the monitoring, and an access controller 60 configured to manage an interface between a cellular base station and a radio access control device according to a result of determining whether to switch the mode.

The state identifier 40 according to the embodiment of the present invention identifies a terminal density, a data transmission speed, and a mobility demand level.

The mode switcher 50 according to the embodiment of the present invention identifies whether a usage according to a service category for each terminal is greater than a threshold value and considers a quality of service (QoS) demand level of an application in execution to determine whether to switch the mode.

The access controller 60 according to the embodiment of the present invention identifies whether the usage exceeds an AP capacity and switches a path into a neighboring AP.

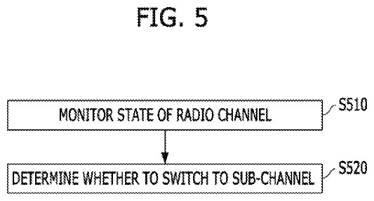

FIG. 5 is a flowchart showing a method of multi-mode integrated management for a multi-radio communication environment according to an embodiment of the present invention.

The method of multi-mode integrated management for the multi-radio communication environment according to the embodiment of the present invention includes monitoring a state of a radio channel (S510) and determining whether to switch to a sub-channel other than a main channel according to a result of the monitoring (S520).

In operation S510, the usage according to a service category for each terminal is calculated and compared with a threshold value.

In operation S520, it is determined whether to continue providing a cellular service or switch a mode in consideration of the result of the monitoring and a QoS demand level.

In operation S520, it is determined whether to switch the channel in consideration of at least one factor of a terminal density, a data transmission speed, and mobility.

In operation S520, after the switching to the sub-channel, it is determined whether the usage exceeds an AP capacity to determine whether to switch a path into a neighboring AP.

According to the embodiment of the present invention, the method may further include, after operation S520, transmitting a transfer command for a neighboring AP.

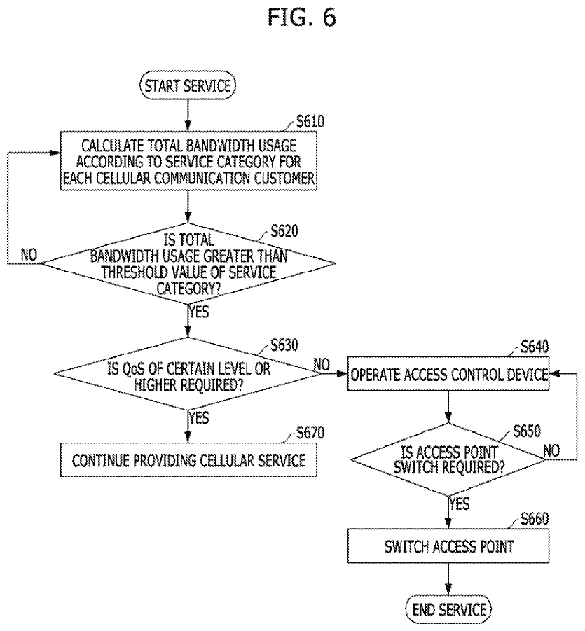

FIG. 6 illustrates a detailed flowchart showing a method of multi-mode integrated management for a multi-radio communication environment according to an embodiment of the present invention, and hereinafter, a procedure of setting a traffic switching threshold and switching to a neighboring access point according to a service policy with reference to FIG. 6.

According to the embodiment of the present invention, a channel state is identified, and when a state of a main channel does not reach a predetermined level and the channel is switched into a sub channel, control information is transmitted to a controller in operation.

The total bandwidth usage according to a service category of each customer of a cellular communication is calculated (S610).

It is determined whether the calculated total bandwidth usage is greater than a preset threshold value of the service category (S620).

When it is determined as a result of comparison in S620 that the total bandwidth usage is greater than the preset threshold value, it is determined whether a QoS of a certain level of higher is required (S630), and when a QoS of a certain level of higher is required, that is, in the case of an application that continuously needs to have allocations of constant bandwidths, a service through a cellular network continues to be provided (S670).

A cellular base station, as a main node, transmits and receives a control message through the access control device serving to distribute traffic and an interface and moves some communication channels that have been transmitting and receiving data to and from a terminal through cellular radio resources controlled by the cellular base station such that the some communication channels are serviced through WiFi and allows a service, for which a certain level of QoS does not need to be ensured, to be provided using a WiFi communication network (S640).

An AP is a device that operates in a similar way as in an Ethernet hub, and in an infrastructure network model, serves to group wireless clients located around a hotspot into a single network such that the wireless clients communicate with each other and also enables connection to another hotspot, a backbone, or a wide area network (WAN) via an Ethernet line connected to the hotspot.

Each hotspot is assigned a unique service set identifier (SSID) and a basic service set identifier (BSSID) to assist a client in connecting to a specific hotspot.

A single hotspot may construct a network in a scale of up to 100 meters and construct 20 networks in a no-obstacle area, but with the introduction of 5G and IEEE802.11ax, may simultaneously accommodate more subscribers and achieve high data rates.

According to the embodiment of the present invention, it is identified whether the usage exceeds an AP capacity (S650), and when the usage exceeds the AP capacity, a service is provided by switching a path into a neighboring AP (S660).

TABLE 2

| | | Based on performance |
|---|---|---|
| Bandwidth | MIMO | of 5 GHz (Mbps) |
| 80 MHz | 1 × 1 | 300 or higher |
| | 2 × 2 | 500 or higher |
| | 3 × 3 | 650 or higher |
| | 4 × 4 | 850 or higher |
| 160 MHz | 1 × 1 | 500 or higher |
| | 2 × 2 | 850 or higher |
| 80 + 80 MHz | 3 × 3 | 500 or higher |
| | 4 × 4 | 850 or higher |

According to the embodiment of the present invention, a wireless network provides a wired network with two types of data, that is, a data plane and a control plane.

In this case, the data plane is a majority part of data transmitted to and received from wireless clients, and the control plane is mode management data for wireless network operation.

Without the control plane, APs operate individually, and the control plane enables control and management of a plurality of APs to be centrally performed so that the operation is performable in one wireless network.

WLAN network construction schemes are divided into a centralized scheme and a distributed scheme. When selecting a WLAN architecture, the basic considerations include deployment costs, security, and manageability.

The centralized scheme requires a WLAN switch (a mobility controller) associated with one or more servers or APs, and all radio traffic is transmitted through the WLAN switch.

The centralized scheme is employed when the number of APs is large and basically employs overlay technology such that an AP network is installed on the existing Ethernet network.

The distributed scheme has an AP itself including WLAN security, layer 2 bridging, and access control functions, and when a management function is required at the center due to an increasing scale of AP installation, a management tool may be added at the center, or the AP may serve as a virtual mobility controller.

The WLAN architecture is defined as an autonomous architecture, a centralized (controller-based) architecture, or a cooperative (controller-less) architecture.

An autonomous AP is a stand-alone type AP, is also referred to as a fat-AP, and includes functions for operating without assistance of other devices.

The autonomous APs operate in all of the three network planes, that is, a management plane, a control plane, and a data plane.

The autonomous APs communicate with each other over a wired backhaul infrastructure network and may provide clients with seamless roaming without an additional active management function.

AP setting is fixed at a time of installation and is applied to a small office/home office (SOHO).

The centralized (controller-based) architecture requires a centralized controller at the end of a network and performs WAN operation control and management through the centralized controller.

APs that require a controller are lightweight type APs, are also referred as thin-APs, and mainly serve as RF transceivers.

The APs mainly operate in the data plane, and the controller performs data forwarding and routing and network configuration and management in the management plane and the control plane.

The thin-APs communicate with client devices or other APs under strict control of the controller.

AP dynamic configuration may be performed to optimize the performance by allocating channels according to a circumstance of a usage environment in real time, adjusting AP output, and providing a client load balancing and other functions.

The centralized (controller-based) architecture is mainly used for large-scale WLANs (hundreds to thousands of clients), and is applied to a network management systems (NMS) for wireless network management.

The cooperative (controller-less) architecture uses a virtual management (cloud based) system.

A minimum number of wired APs are used, and WLANs are managed and controlled using cooperative communication between the APs.

The cooperative (controller-less) architecture uses cooperative routing and message protocols and provides control between a full-featured AP and Aps.

As a result, the controller becomes virtual and passive, and the APs handle the control and data.

A management interface for configuring and managing AP specifications is accessible from anywhere, and a system administrator does not need to be at the site at which the AP is installed to access the network to control the AP.

WLAN controllers are defined as follows.

A cloud-based type is a solution of the most common WLAN network, in which a controller is not installed in a workplace (controller-less) but a controller located in a data center is used by connection to the Internet.

The cloud-based type requires joining the data center and paying for the usage fee and is the simplest form of wireless AP network operation due to ease of WLAN network installment and management.

An AP-based type is a controller-less scheme in which an AP itself is equipped with a controller function.

One AP is selected as a controller to manage other APs, and APs manageable by one AP are significantly limited. Accordingly, the AP-based type is used only in a small AP network.

The AP-based type does not require an additional controller and also does not perform powerful controller functions as compared to a dedicated controller.

A virtual controller-based type is a virtual machine based wireless controller and is a form optimized with a virtual machine without installing a physical controller in a workplace that operates its own data center.

The virtual controller-based type is suitable for a workplace that operates its own data center and has a strong WM.

A physical controller-based type is a scheme in which a physical dedicated controller is installed in a workplace and provides the most powerful control function.

A control plane data only controller solution is provided as a private cloud and on-premise cloud solution. Such a scheme delivers cloud signals in a similar way as in the cloud scheme while using the Internet rather than the cloud.

A “control plane”+“data plane data” controller solution provides the most powerful control function. Without securing a controller suitable for a WiFi network in the future, the entire wireless network may have a severe failure.

The physical controller may use stateful or non-stateful high availability (HA) to prevent a wireless network from having an outage.

The stateful HA scheme corresponds to a primary controller+stateful HA, in which a stateful HA controller concurrently operates as a copied form of a primary controller, and when a fault occurs in an operation of the primary controller, the stateful HA controller receives the operation and performs the same.

A non-stateful HA scheme is provided for a backup of a controller in operation and replaces the controller in operation when the controller fails.

Meanwhile, the system and method for multi-mode integrated management for multi-radio communication environment according to the embodiment of the present invention may be implemented in a computer system or may be recorded on a recoding medium. The computer system may include at least one processor, a memory, a user input device, a data communication bus, a user output device, and a storage. The above described components perform data communication through the data communication bus.

The computer system may further include a network interface coupled to a network. The processor may be a central processing unit (CPU) or a semiconductor device for processing instructions stored in the memory and/or storage.

The memory and the storage may include various forms of volatile or nonvolatile media. For example, the memory may include a read only memory (ROM) or a random-access memory (RAM).

Therefore, the method of multi-mode integrated management for multi-radio communication environment according to the embodiment of the present invention may be implemented in the form executable by a computer. When the method of multi-mode integrated management for multi-radio communication environment according to the embodiment of the present invention is performed by the computer device, instructions readable by the computer may perform the method of multi-mode integrated management for multi-radio communication environment according to the present invention.

Meanwhile, the method of multi-mode integrated management for multi-radio communication environment according to the embodiment of the present invention may be embodied as computer readable codes on a computer-readable recording medium. The computer-readable recording medium is any data storage device that can store data that can be read thereafter by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable codes may be stored and executed in a distributed manner.

As is apparent from the above, in order to maximally utilize a cellular-based communication system, such as LTE or 5G, as efficiently as possible, a wireless LAN (WLAN), such as IEEE802.11ax, is used in combination therewith so that smooth data transmission in an area in which a large number of users gather, such as a user dense region, can be ensured.

According to the embodiment of the present invention, in a situation in which communication performance is degraded in a user dense region, the communication capacity is increased through a multiplexing system so that a failure can be prevented from occurring during data transmission such as a high-speed image transmission.

It should be understood that the effects of the present disclosure are not limited to the above effects and include all effects that can be deduced from the detailed description of the present disclosure or the configuration of the present disclosure described in the claims.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

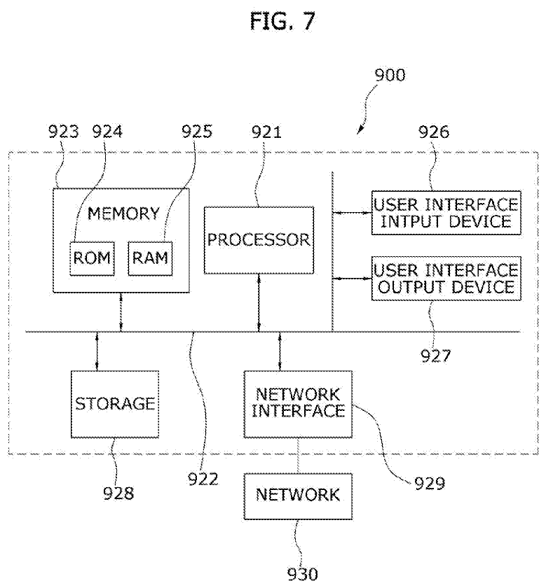

The method according to an embodiment of the present invention may be implemented in a computer system or may be recorded in a recording medium. FIG. 7 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

N1 interface is a signalling procedures between STA of UE and AMF of 3GPP core network to support Authentication and Mobility Function (AMF) for WLAN access network.

NWu interface is a signalling procedures between STA of UE and UPF of 3GPP core network to support secured IP tunneling for WLAN access network.

Y2 interface is a wireline communication protocol between WLAN access network and N3IWF of 3GPP core network for transport of traffic data and control data.

According to present invention, it discloses interworking between 3GPP 5G network and WLAN will provide a reference and guideline for stakeholders with interest in standardization and system development.

According to present invention, it discloses an interworking reference model, necessary functionalities and specific procedures that allow WLAN access network to interwork with 3GPP 5G network.

We consider two types of interworking reference model, which are tightly coupled and loosely coupled type.

The reference model consists of WLAN stations (STAs), WLAN access network (consisting of WLAN access point (APs) and a Distribution System (DS)), 3GPP 5G access network and 3GPP 5G core network.

N1 signalling and NWu interfaces are defined in 3GPP specification, but functionalities and procedures are not defined in WLAN entities to allow for interworking with 3GPP 5G network.

According to present invention, it discloses Y2 interface and new functional entities, which are Station Controller (SC) in a station and Access Network Controller (ANC) in WLAN access network.

The signalling and control procedures will be described for the functional entities of a station, WLAN access network, 3GPP 5G access network and 3GPP 5G core network.

The reference model consists of WLAN stations (STAs), WLAN access network (consisting of WLAN access point (APs) and a Distribution System (DS)), 3GPP 5G access network and 3GPP 5G core network.

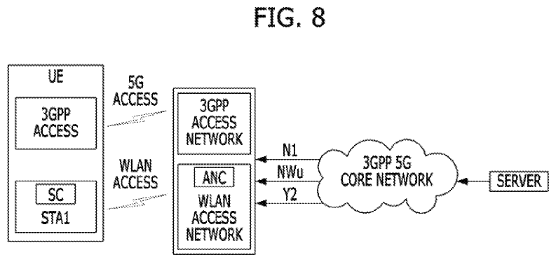

WLAN convergence to 3GPP network will have two types of interworking reference model, which are tightly coupled and loosely coupled type. At first, tightly coupled interworking model is shown as FIG. 8.

It has combined functional entities in UE and access network at the same location, and only 3GPP core network is connected with the defined interfaces N1, NWu and Y2.

Loosely coupled interworking model has separate functional entity in access network at the different location.

3GPP core network is connected to WLAN access network with the defined interfaces N1, NWu and Y2.

N1 signalling and NWu interfaces are defined in 3GPP specification, but functionalities and procedures are not defined in WLAN entities to allow for interworking with 3GPP 5G network.

N1 is signalling procedures between STA of UE and AMF of 3GPP core network to support Authentication and Mobility Function (AMF) for WLAN access network.

NWu is signalling procedures between STA of UE and UPF of 3GPP core network to support secured IP tunneling for WLAN access network.

Y2 interface is wireline communication protocol between WLAN access network and N3IWF of 3GPP core network for transport of traffic data and control data.

According to present invention, it discloses Y2 interface and new functional entities, which are Station Controller (SC) in a station and Access Network Controller (ANC) in WLAN access network.

The signalling and control procedures will be described for the functional entities of a station, WLAN access network, 3GPP 5G access network and 3GPP 5G core network.

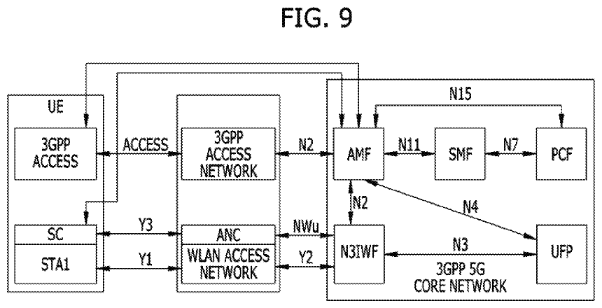

WLAN interworking function model consists of UE, access network and 5G core network as shown in FIG. 9.

Station controller (SC) in UE provides networking function and communication protocol to WLAN access network and AMF of 3GPP 5G core network.

And access network controller (ANC) of WLAN access network provides networking function and communication protocol to SC and STA of UE and N3IWF of 3GPP 5G core network.

Y1 reference is wireless access between STA of UE and wireless access network, which includes physical and MAC layer.

Y3 reference is signalling procedures between SC of UE and ANC of WLAN access network to support secured IP tunneling for WLAN access network.

Y2 interface is wireline communication protocol between WLAN access network and N3IWF of 3GPP core network for transport of traffic data and control data.

NWu interface is signalling procedures between STA of UE and UPF of 3GPP core network to support secured IP tunneling for WLAN access network.

N1 interface is signalling procedures between STA of UE and AMF of 3GPP core network to support Authentication and Mobility Function (AMF) for WLAN access network.

Interworking for a UE containing both 3GPP 5G and WLAN radios is tightly coupled because WLAN access network and 3GPP access network are co-located and interworking may be done efficiently.

Function and procedures for two interworking are as follows.

Radio channel sharing method

SC of STA monitors the usage of WLAN access network if the radio channel is busy or idle. If the radio channel is idle, UE try to send control or traffic data.

Registration and authentication function and its message procedures

STA shall initially support registration and authentication to be connected between UE and N3IWF.

NWu for registration and authorization involves IP protocol, IKEv2 and EAP-5G protocol. And N1 signalling is needed to exchange NAS signal.

Registration and authentication function

SC of UE and ANC of WLAN access network shall have specific functional requirements to interwork with 3GPP 5G core network

IP communication protocol

IKEv2 authorization protocol

EAP-5G protocol

NAS signaling

Interworking between WLAN access network and 3GPP core network shall have the following interface

Y2 interface is wireline PHY and MAC layer interface between WLAN access network and N3IWF of 3GPP 5G core network.

NWu signal interface is registration and authentication signal interface between WLAN access network and N3IWF of 3GPP core network.

N1 signal interface is NAS signal interface between UE and AMF of 3GPP core network.

Message procedures

Y2 interface

Y2 interface is PHY/MAC communication protocol between ANC of WLAN access network and N3IWF of 3GPP 5G core network.

Ethernet RJ45 connector and CSMA/CD protocol following IEEE 802.3 standard is commonly applied.

NWu interface

NWu interface is IP based communication protocol between SC of WLAN access network and N3IWF of 3GPP 5G core network to establish secured data channel. IKEv2 authorization protocol and EAP-5G protocol is applied.

NWu interface

NWu interface is IP based communication protocol between SC of WLAN access network and N3IWF of 3GPP 5G core network to establish secured data channel. IKEv2 authorization protocol and EAP-5G protocol is applied.

N1 interface

N1 interface is secured IP communication protocol between UE of WLAN access network and AMF of 3GPP 5G core network to provide NAS signaling.

Signalling function and its message procedures

STA shall initially support secured IP transport between UE and UPF, and traffic data is exchanged over the established IP channel.

Signalling function

SC of UE and ANC of WLAN access network shall have specific functional requirements to interwork with 3GPP 5G core network.

IP communication protocol

IPsec communication protocol

GRE communication protocol

Interworking between WLAN access network and 3GPP core network shall have the following interface.

Y2 interface is wireline PHY and MAC layer interface between WLAN access network and N3IWF of 3GPP 5G core network.

NWu control signal interface is secured IP channel and GRE protocol interface between WLAN access network and N3IWF of 3GPP core network.

PDU packer data interface is packet data interface between UE and UPF of 3GPP core data.

Message procedures

ATSSS function and its message procedures

Traffic data shall be transmitted over WLAN access channel and/or 3GPP access channel by using ATSSS function.

3GPP supports ATSSS between 3GPP and non-3GPP access networks.

ATSSS can enable traffic selection, switching and splitting between 5G and WLAN.

QoS function and its message procedures.

WLAN has ECCA to assign QoS values in WLAN MAC layer and network slicing shall provide QoS management in 3GPP core network domain. To provide adaptive QoS management in terms of data rate, message latency. It shall share provide QoS mapping between MAC layer and Network slicing in 5G core network.

What is claimed is:

1. A system for multi-mode integrated management for a multi-radio communication environment, the system comprising:
a receiver configured to receive radio channel state information;
a memory in which a program for operating an access point division in consideration of the radio channel state information is stored; and
a processor configured to execute the program,
wherein the processor manages an interface between a cellular base station and a radio access control device.

2. The system of claim 1, wherein the processor manages the interface in consideration of at least one factor of a terminal density, a data transmission speed, and mobility.

3. The system of claim 1, wherein the processor calculates a total bandwidth usage according to a service category for each terminal and compares the calculated total bandwidth usage with a threshold value.

4. The system of claim 3, wherein the processor determines whether to continue providing a cellular service in consideration of a quality of service (QoS) demand level when the total bandwidth usage is greater than the threshold value.

5. The system of claim 4, wherein the processor provides a service using a WiFi communication network according to the QoS demand level, monitors whether the usage exceeds an access point capacity, and switches a path into a neighboring access point when the usage exceeds the access point capacity and provides the service.

6. The system of clam 5, wherein the processor transmits a transfer command for the neighboring access point.

7. A method of multi-mode integrated management for a multi-radio communication environment, the method comprising the steps of:
(a) monitoring a state of a radio channel; and
(b) determining whether to switch to a sub-channel other than a main channel according to a result of the monitoring.

8. The method of claim 7, wherein in step (a), a total bandwidth usage according to a service category is calculated for each terminal and compared with a threshold value.

9. The method of claim 7, wherein in step (b), whether to continue providing a cellular service or switch a mode is determined in consideration of the result of the monitoring and a quality of service (QoS) demand level.

10. The method of claim 7, wherein in step (b), whether to switch the channel is determined in consideration of at least one factor of a terminal density, a data transmission speed, and mobility.

11. The method of claim 7, wherein in step (b), after the switching to the sub-channel, whether a usage exceeds an access point capacity is monitored to determine whether to switch a path into a neighboring access point.

12. The method of claim 11, further comprising (c) transmitting a transfer command for the neighboring access point.

13. A system for multi-mode integrated management for a multi-radio communication environment, the system comprising:
a state identifier configured to monitor a radio channel state;
a mode switcher configured to determine whether to switch a mode according to a result of the monitoring; and
an access controller configured to manage an interface between a cellular base station and a radio access control device according to a result of determining whether to switch the mode.

14. The system of claim 13, wherein the state identifier identifies a level of demand for a terminal density, a data transmission speed, and mobility.

15. The system of claim 13, wherein the mode switcher identifies whether a usage according to a service category for each terminal is greater than a threshold value and considers a quality of service (QoS) demand level to determine whether to switch the mode.

16. The system of claim 13, wherein the access controller identifies whether a usage exceeds an access point capacity to switch a path into a neighboring access point.
